(19) United States
(12) Patent Application Publication
(10) Pub. No.: US 2016/0136026 A1
(43) Pub. Date: May 19, 2016

(54) Infant Warming Device with Remote Display and Control

(71) Applicant: SEGARS CALIFORNIA PARTNERS, LP, Austin, TX (US)

(72) Inventor: Peter D. Sabota, Austin, TX (US)

(73) Assignee: Segars California Partners, LP, Austin, TX (US)

(21) Appl. No.: 14/900,152

(22) PCT Filed: Jun. 14, 2014
(86) PCT No.: PCT/US2014/042438

§ 371 Date: Dec. 19, 2015

Related U.S. Application Data
(60) Provisional application No. 61/835,523, filed on Jun. 14, 2013.

(51) Int. Cl. A61G 11/00

(52) U.S. Cl. CPC A61G 11/00; A61G 2203/16

(57) ABSTRACT

A bi-directional remote communications system with both display and control capability allowing 2 way communications between one or more remote devices and one or more infant warming devices. The system could update the remote device with all current display parameters and information from the infant warming device and will also allow changes made on the handheld device to update the infant warming device.

### CROSS-REFERENCE TO RELATED APPLICATIONS

This application claims the benefit of U.S. Provisional application 61/835,523 filed Jun. 14, 2013.

### BACKGROUND

This disclosure relates to the field of various infant warming devices that are used to provide heat support to premature infants who cannot sustain their own body temperature. In the treatment of infants, and particularly those born prematurely, it is necessary to provide heat to the infant during the care and treatment of the infant and to minimize heat loss from the infant's body. An apparatus for providing such heat will be referred to in this disclosure as an infant warming device. In general such an apparatus comprises a flat planar surface on which the infant rests while various procedures are carried out. There are normally protective guards that surround the infant and some type of overhead heater directing radiant energy toward the infant. It should be understood that these infant warming devices might have other descriptive names, such as, for example, an infant care device, or an infant care center, patient care center, an infant incubator, or a combination device, and this disclosure anticipates any of those other names. This disclosure will use the term infant warming device.

Infant warming devices currently have integrated user interfaces. The operations of these devices are limited to user interactions that occur only at the device. In the use of these products during normal and emergency situations (“Code” situations) there can be a large number of personnel at the bedside and making input of changes to the device difficult.

A Code is medical terminology for a situation where a patient experiences a life threatening event such, for example, cardiopulmonary arrest, requiring a team of providers (sometimes called a “Code team”) to rush to the specific location and begin immediate resuscitative efforts. It is not uncommon for an infant patient to experience a Code following delivery or while being cared for in an intensive care area. The Code team ideally consists of 4-6 people, each with defined roles, though often fewer are available. A Code is an intense period of time involving many people and can have very serious consequences. An infant warming device is often the platform on which an infant code is treated.

In these situations it is cumbersome to silence alarms, make changes to key parameters, enter patient data, or log other events that are occurring at that time.

There is a need then for a system that enables can enable caregivers to input changes to the infant warming device, and to see key parameters, log events, and to make setting changes without being directly at the integrated user interface.

### BRIEF SUMMARY

This need can be met by providing one or more remote display and control devices with bi-directional remote communications system that will allow 2-way communications between the infant warming device and the one or more remote devices that would update of the remote device with all current display parameters and information from the infant warming device and will also allow changes made on the remote devices to update the main device. This communications could be wireless but it also could also be a wired, or through the internet. This would allow a caregiver to stand away from the infant warming device and display and enter data into the device or change device parameters. This would be especially useful in patient code situations.

The need can also be met by an infant warming device including a patient bed, supporting sidewalls, associated warming mechanisms, a main computer controller, and a vertical column structure mounted on the infant warming device that supports a radiant heater head containing a radiant heater assembly that is one of the associated warming mechanisms including at least: a graphic display user interface or touchscreen mounted into the vertical column structure and in bi-directional communication with the main computer controller and can be used for both the input and output of information; one or more remote display and control devices separate from the infant warming device; wherein the one or more remote display and control devices also communicate bi-directionally with the main computer controller and have some or all of the functionality of the graphic display user interface and can access data from and enter information, or change device parameters into the infant warming device.

### DESCRIPTION OF DRAWINGS

There are disclosed in the drawings and detailed description to follow various embodiments of the solution proposed herein. It should be understood, however, that the specific embodiments given in the drawings and entailed description do not limit the disclosure. On the contrary, they provide the foundation for discerning the alternative forms, equivalents, and modifications that will be encompassed in the scope of the eventual claims.

FIG. 1 is a view of an infant warming device that can include the inventive concept described in this disclosure.

FIG. 2 is an alternate view of an infant warming device that can include the inventive concept described in this disclosure.

FIG. 3 is an alternate view of an infant warming device that can include the inventive concept described in this disclosure.

FIG. 4 is a view illustrating the bi-directional communication between the infant warming device and the proposed remote device.

FIG. 5 is a view illustrating an embodiment of the remote device screen displaying key parameters and a Code Screen for emergency situations.

### DETAILED DESCRIPTION

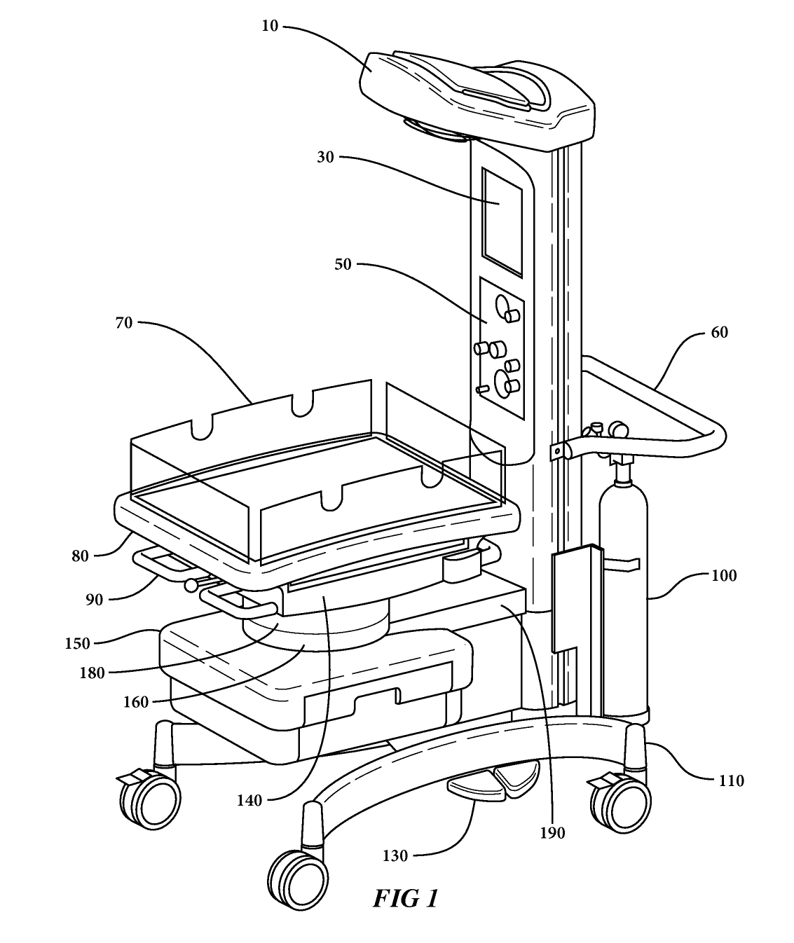

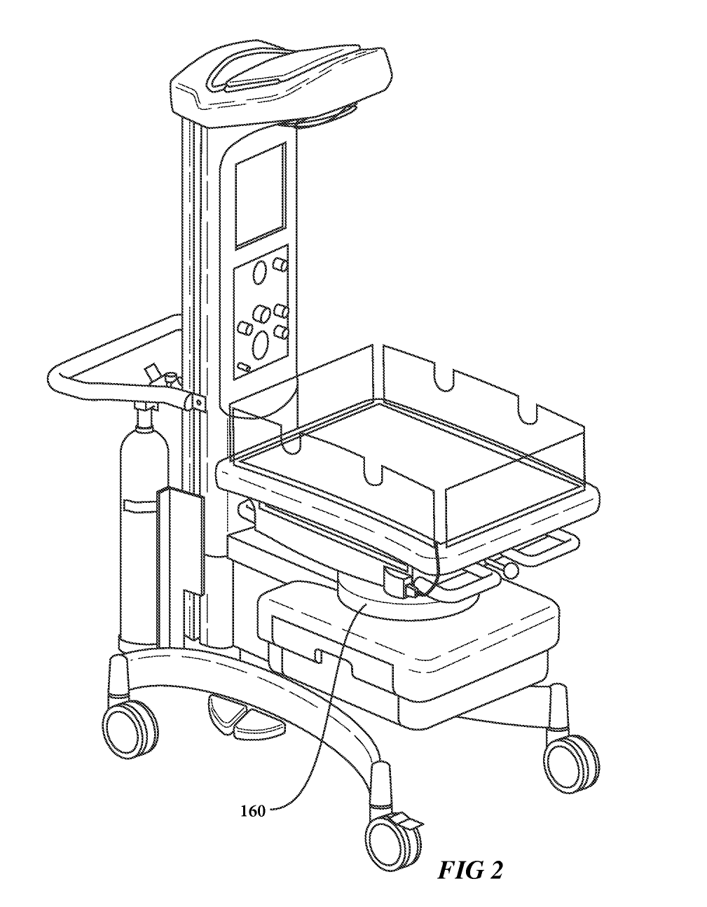

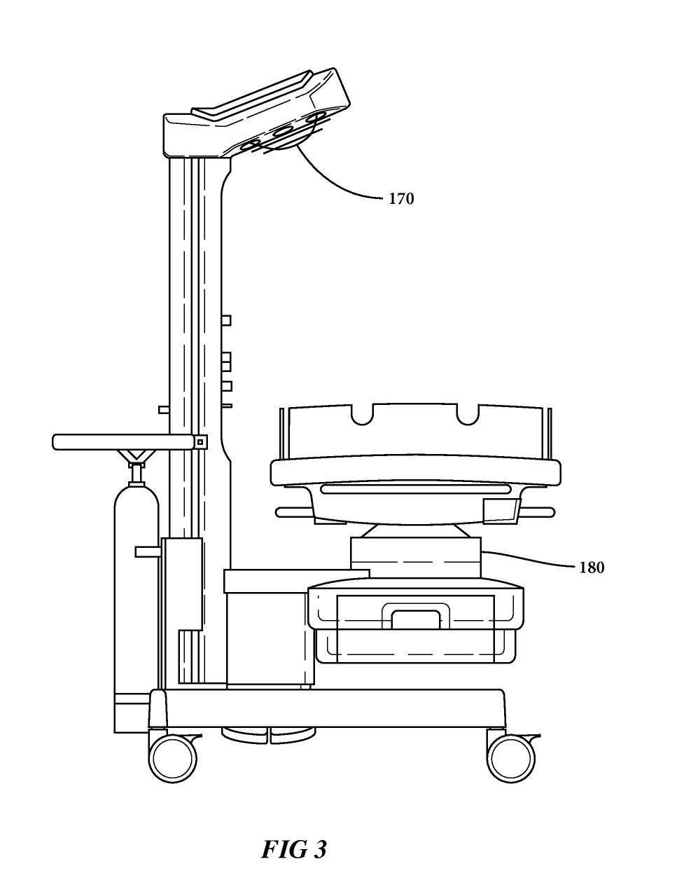

Referring now to FIGS. 1, 2, and 3, several views of an infant warming device that can include the inventive concept to be described in this disclosure. The center includes an infant bed 80 that underlies an infant positioned thereon. The infant bed has a surrounding sidewall 70 and rides upon a patient support mechanism 140. The patient bed and surrounding sidewalls may enclose a heated mattress. A vertical column structure mounted on the infant warming center supports a radiant heater head 10, containing a radiant heater 170 (FIG. 3), with that radiant heater. The radiant heater assembly is designed to optimize the heat focused on the infant. The vertical column structure may have an integrated user interface/display or touchscreen 30 which can be used for both input and output of information. That information can include collected data on the patient from sensors as well as data from the infant warming device itself. This integrated user interface can also display videos with accompanying audio stored in the memory of the infant warming device. These could be directed to the caregivers, for example training videos, or could be used at other times to show family pictures, or to show an image of the infant if the infant warming device has a still or video camera mounted on the vertical column structure.

The column may include a resuscitation module 50. The infant warming device's main computer controller may reside in the vertical column structure or may reside in the patient support mechanism. The main computer controller contains the computer software for operation of the infant warming device and memory for storage of information, videos, audio files, etc. Handles 60, 90, are used to move the infant warming device around as it can be moved on flat surfaces via legs 110 with attached wheels and controlled with footswitches 130. On the rear side of the column is a location for carrying a remote gas supply tank 100. Under the patient support mechanism 140 is a cantilever cover 160 and turret cover 180 for shrouding the rotation mechanisms, with a cantilever arm 190 that supports the patient support, vertical column, and supports a storage enclosure 150.

Embedded software in the main computer controller of the infant warming device can include special emergency Code data and instructions that appear on the user interface/display or touchscreen 30 during emergency Codes. During this time an emergency Code team uses the touchscreen to log data and change parameters or settings during the emergency.

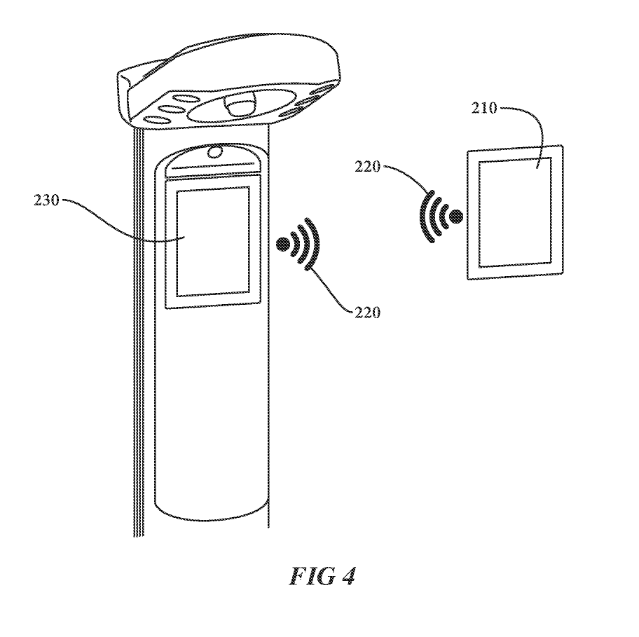

FIG. 4 illustrates bi-directional communication between the infant warming device and the proposed remote device. An integrated user interface 230 is mounted in the pedestal of the infant warming device and the remote display and control device 210 is shown with a similar screen. Although the illustrated remote display screen 210 can show the same information as that available to the integrated user interface 230 the actual displays do not have to be in sync with respect to the data being shown. For example, the remote display could be opening different help screens, or accessing a video while the integrated user interface screen does not change. The remote display may access any of the video/audio files stored on the infant warming device and show them remotely. In the case of audible alarms being sounded the remote display device could silence or lower the alarm volume remotely. The remote display device could also be used to change the lighting for the infant warming center remotely. Text communications (Notes) could be entered from any of the remote displays to improve communications between caregivers on the same and on different shifts. The Notes could be saved and communicated from any of the remote display and control devices.

Communication 220 between the two devices is shown as wireless. The possibility of a wired remote user interface is not shown but also anticipated. The proposed remote display and control device 210 would have some or all of the functionality of integrated user interface 30 and can access data from and enter information or instructions into the infant warming device. This would allow caregivers to access key parameters and enter information or log data into the device or change device parameters in the infant warming device without being directly at the integrated user interface. During emergency Code procedures the remote display and control device may be used by key members of the emergency Code procedure without them being directly at the infant warming device do to the possibly crowded conditions of an emergency Code.

Any of the one or more remote display and control devices can independently access and display information from the infant warming device not currently displayed on the screen of the graphic display user interface or touchscreen mounted into the vertical column structure.

In addition to wireless and wired communication the information between the main controllers of the infant warming device could be through the internet. This would allow additional remote devices that could be at more remote caregiver locations and the remote device could then be implemented on desktop, laptop, tablet, pad device, or a smartphone. This might require the development of a computer app or a dedicated computer website. In this way the key parameters could be viewed or changed via the Internet to and from a more remote caregivers stations, using a desktop, laptop, tablet, pad device, or a smartphone device.

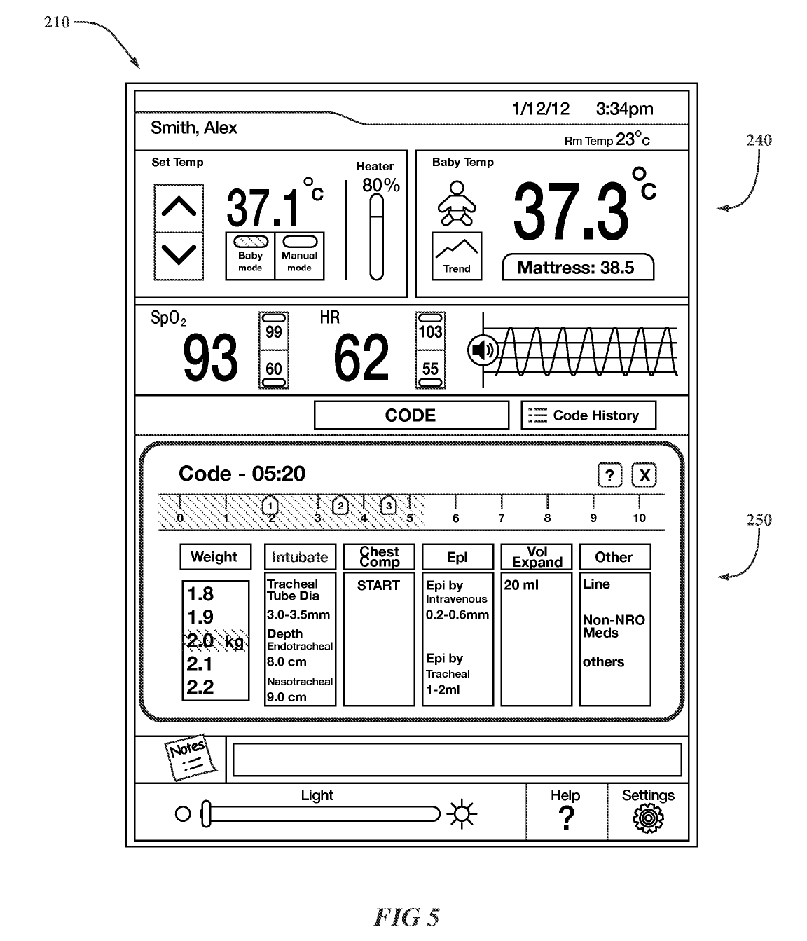

FIG. 5 is a view illustrating an embodiment of the remote device screen 210 displaying key parameters 240 of the patient or the equipment and a Code Screen 250 that appears during for emergency Code situations. It is anticipated that one remote display could show the data and change parameters on multiple infant warming devices by toggling between them, or could show the data and change parameters on multiple infant warming devices simultaneously by the use of smaller split screens.

### Advantages of the Invention Over the Prior Art

The described communications system that will allow 2-way communications between the device that would update the remote device with all current display parameters and information from the device and will also allow changes made on the handheld device to update the main device. This would allow a caregiver to stand away from the device and enter data into the device or change device parameters. This would be especially useful in emergency patient code situations.

What is claimed is:

1. An infant warming device including a patient bed, supporting sidewalls, associated warming mechanisms, a main computer controller, and a vertical column structure mounted on the infant warming device that supports a radiant heater head containing a radiant heater assembly that is one of the associated warming mechanisms comprising:
a graphic display user interface or touchscreen mounted into the vertical column structure and in bi-directional communication with the main computer controller and can be used for both the input and output of information;
one or more remote display and control devices separate from the infant warming device;
wherein the one or more remote display and control devices also communicate bi-directionally with the main computer controller and have some or all of the functionality of the graphic display user interface and can access data from and enter information, or change device parameters into the infant warming device.

2. The infant warming device of claim 1 further comprising:
embedded software in the main computer controller that includes emergency Code response data and instructions that display onto the graphic display user interface during emergency Code situations;
wherein the one or more remote display and control devices that communicate bi-directionally with the main computer controller and can access emergency Code data from and enter emergency Code information or enter data into the device.

3. The infant warming device of claim 1 wherein the bi-directional communication between the one or more remote displays and the main computer controller of the infant warming device is wireless.

4. The infant warming device of claim 1 wherein the bi-directional communication between the one or more remote displays and the main computer controller of the infant warming device is wired.

5. The infant warming device of claim 1 wherein the one or more remote display and control devices can communicate with more than one infant warmer devices by toggling between them.

6. The infant warming device of claim 1 wherein the one or more remote display and control devices can communicate with more than one infant warmer devices simultaneously using split screens.

7. The infant warming device of claim 1 wherein the one or more remote display and control devices can silence or lower the alarm volume from the infant warming device.

8. The infant warming device of claim 1 wherein the one or more remote display and control devices can change the lighting for the infant warming device.

9. The infant warming device of claim 1 wherein the one or more remote display and control devices can independently access and display information from the infant warming device not currently displayed on the screen of the graphic display user interface or touchscreen mounted into the vertical column structure.

10. The infant warming device of claim 1 wherein the bi-directional communication between the one or more remote displays and the main computer controller of the infant warming device is through the internet.

11. The infant warming device of claim 10 wherein the one or more remote display and control devices are implemented on a desktop, laptop, tablet. pad device, or a smartphone.

12. The infant warming device of claim 1 wherein the one or more remote display and control devices have a text communication feature that allows caregivers to save and communicate notes to other caregivers.
